(19) United States
(12) Patent Application Publication
(10) Pub. No.: US 2025/0303546 A1
(43) Pub. Date: Oct. 2, 2025

(54) ADJUSTABLE HAND TOOL

(71) Applicant: Tang Chou Industrial Co., Ltd., Nantou County (TW)

(72) Inventor: Mou-Tang LIOU, Taichung City (TW)

(21) Appl. No.: 18/624,716

(22) Filed: Apr. 2, 2024

(51) Int. Cl. B25G 3/38; B66F 15/00

(52) U.S. Cl. CPC B25G 3/38; B66F 15/00

(57) ABSTRACT

An adjustable hand tool includes a rod, a tool head, and a pivoting device. The tool head is pivotally connected to the rod. The pivoting device includes an engaging member and an axial member. The engaging member is movably inserted through the tool head and the rod. The engaging member is provided with an engaging portion detachably engaged with an engaging hole of the tool head, and a limiting portion corresponding to a limiting hole of the rod. The axial member is movably inserted through the tool head, and the axial member is fixedly connected to the engaging member to drive the engaging member, allowing the engaging portion to disengage from the engaging hole.

### BACKGROUND OF THE INVENTION

The present invention relates to a hand tool and, more particularly, to an adjustable angle hand tool.

U.S. Pat. No. 11,801,595 discloses a tool including a buffer structure. The tool has a tool head having a connecting portion receiving a pivot. The connecting portion is in a form of a hole and includes first teeth. The pivot is inserted into the hole of the connecting portion and includes second teeth engageable with the first teeth of the connecting portion. When the first and second teeth are engaged with each other, the tool head is restrained from pivoting with respect to the shaft structure.

However, the pivot of the aforementioned tool may be prone to failure due to stress concentration during prying operations, especially at the connecting region between the hexagonal column portion adjacent to the second teeth and the cylindrical portion adjacent to the hexagonal column portion.

Thus, a need exists for an adjustable hand tool to mitigate and/or obviate the above disadvantages.

### SUMMARY OF THE INVENTION

In general, this disclosure describes an adjustable hand tool that includes a rod, a tool head, and a pivoting device. The rod has a first pivoting portion provided with a limiting hole. The tool head has a second pivoting portion provided with an engaging hole, a containing hole, and a containing slot communicating with the engaging hole and the containing hole. The first pivoting portion is pivotally connected to the containing slot. The pivoting device includes an engaging member and an axial member. The engaging member is movably inserted through the engaging hole and the limiting hole, and the engaging member is provided with an engaging portion detachably engaged with the engaging hole, and a limiting portion corresponding to the limiting hole. The axial member is movably inserted through the containing hole, and the axial member is fixedly connected to the engaging member to drive the engaging member, allowing the engaging portion to disengage from the engaging hole.

The present invention will become clearer in light of the following detailed description of illustrative embodiments of this invention described in connection with the drawings.

### BRIEF DESCRIPTION OF DRAWINGS

FIG. 1 is a perspective view of an adjustable hand tool of an embodiment according to the present invention.

FIG. 2 is a partial exploded perspective view of the adjustable hand tool of FIG. 1.

FIG. 3 is another partial exploded perspective view of the adjustable hand tool of FIG. 1.

FIG. 4 is a cross sectional view of the adjustable hand tool of FIG. 1 and shows the engaging member in the locked position.

FIG. 5 is a cross sectional view taken from line 5-5 of FIG. 4.

FIG. 6 is a continued view of FIG. 4 and shows the engaging member in the unlocked position.

FIG. 7 is a continued view of FIG. 5 and shows the engaging member in the unlocked position and the tool head adjusted the angle relative to the rod.

### DETAILED DESCRIPTION OF THE INVENTION

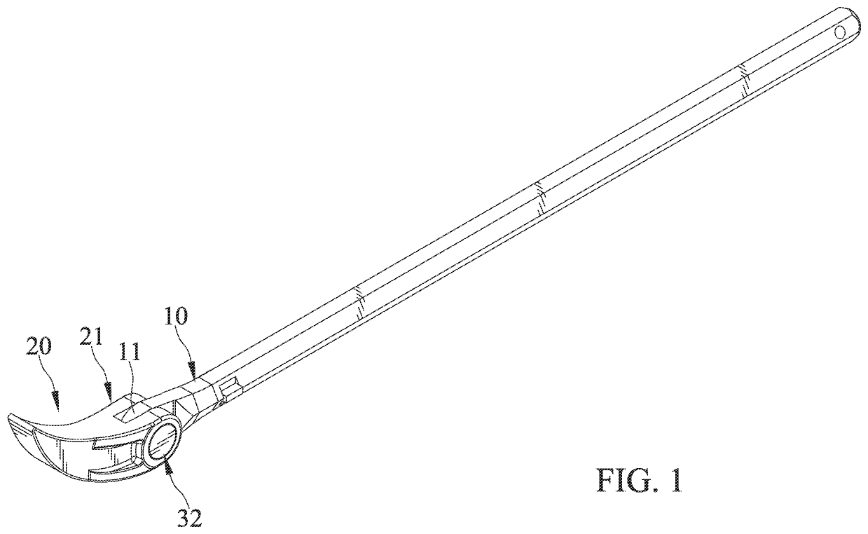

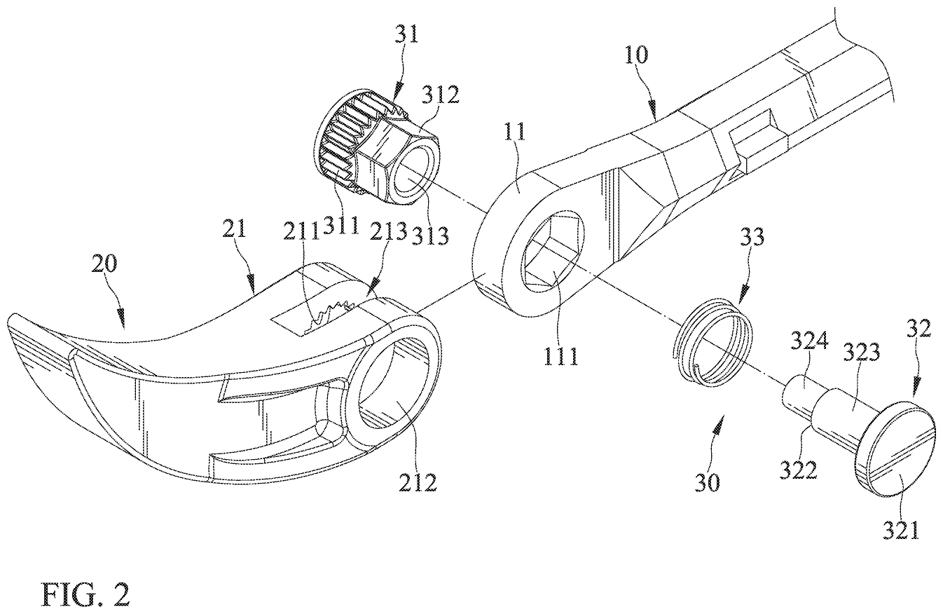

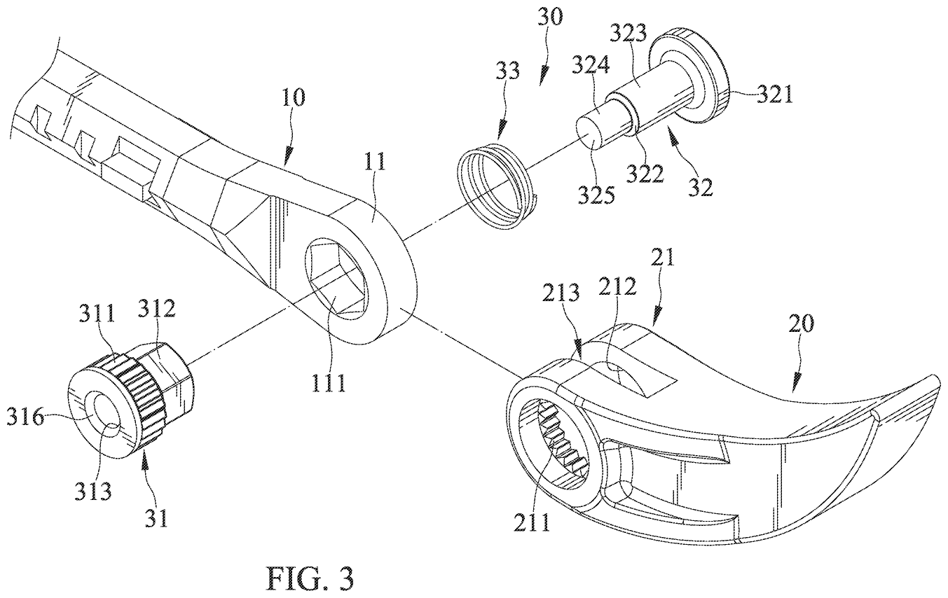

FIGS. 1-7 show an adjustable hand tool of an embodiment according to the present invention. The adjustable hand tool includes a rod 10, a tool head 20, and a pivoting device 30. The rod 10 has a first pivoting portion 11 provided with a limiting hole 111. The tool head 20 has a second pivoting portion 21 provided with an engaging hole 211, a containing hole 212, and a containing slot 213 communicating with the engaging hole 211 and the containing hole 212, and the first pivoting portion 11 is pivotally connected to the containing slot 213. The pivoting device 30 includes an engaging member 31 and an axial member 32. The engaging member 31 is movably inserted through the engaging hole 211 and the limiting hole 111, and the engaging member 31 is provided with an engaging portion 311 detachably engaged with the engaging hole 211, and a limiting portion 312 corresponding to the limiting hole 111. The axial member 32 is movably inserted through the containing hole 212, and the axial member 32 is fixedly connected to the engaging member 31 to drive the engaging member 31, allowing the engaging portion 311 to disengage from the engaging hole 211. Therefore, the tool head 20 can selectively adjust the angle relative to the rod 10 through the pivoting device 30.

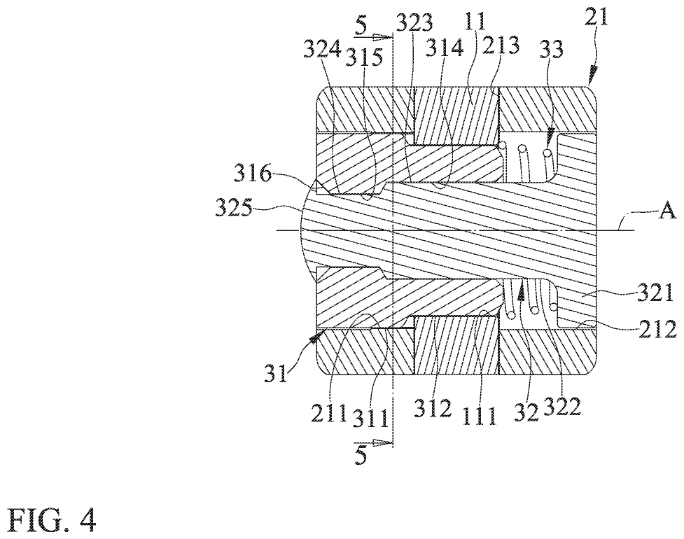

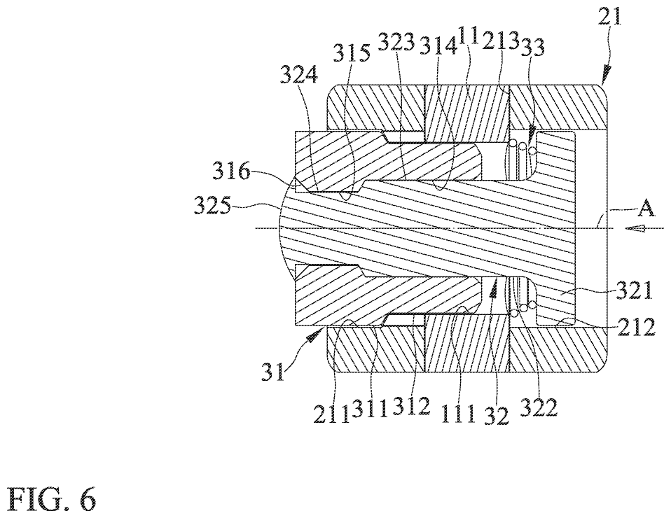

In the embodiment, the engaging member 31 is configured to be driven by the axial member 32 to switch between a locked position (FIG. 4) and an unlocked position (FIG. 6) along an axis A relative to the engaging hole 211 and the limiting hole 111. The axial member 32 is configured to move along the axis A between a first position (FIG. 4) and a second position (FIG. 6) relative to the containing hole 212. When the engaging member 31 is in the locked position and the axial member 32 is in the first position, the engaging portion 311 is engaged with the engaging hole 211. When the engaging member 31 is in the unlocked position and the axial member 32 is in the second position, the engaging portion 311 is disengaged from the engaging hole 211.

The engaging member 31 is provided with a through hole 313 penetrating opposite ends of the engaging member 31 along the axis A. The axial member 32 is provided with a pressing portion 321 disposed in the containing hole 212 and a body 322 extending from the pressing portion 321 along the axis A. The body 322 is fixedly connected to the through hole 313, allowing the axial member 32 to fixedly connected to the engaging member 31 to drive the engaging member 31.

Further, the through hole 313 is provided with a large diameter portion 314 and a small diameter portion 315 along the axis A. The body 322 is provided with a large diameter section 323 extending from the pressing portion 321 and corresponding to the large diameter portion 314, and a small diameter section 324 extending from the large diameter section 323 and corresponding to the small diameter portion 315 along the axis A. Thus, the contact area between the engaging member 31 and the axial member 32 is increased to avoid the problem of damage due to stress concentration.

Furthermore, the through hole 313 is further provided with a riveting portion 316 located on a side of the small diameter portion 315 away from the large diameter portion 314. The body 322 is further provided with a riveting section 325 extending from the small diameter section 324 and exposed outside the small diameter portion 315. The riveting section 325 is riveted to the riveting portion 316.

In the embodiment, the limiting hole 111 may be a polygonal hole, and the limiting portion 312 may be polygonal columnar in shape. Further, the limiting hole 111 is a hexagonal hole, and the limiting portion 312 is hexagonal columnar in shape.

In the embodiment, at least a part of an inner surface of the engaging hole 211 and at least a part of an outer surface of the engaging portion 311 are provided with corresponding teeth.

The pivoting device 30 further includes a biasing member 33 configured to bias the axial member 32 towards the first position. The biasing member 33 has two opposite ends respectively elastically abutting against the first pivoting portion 11 and the pressing portion 321 along the axis A. In the embodiment, the biasing member 33 may be a torsion spring and sleeves around the body 322.

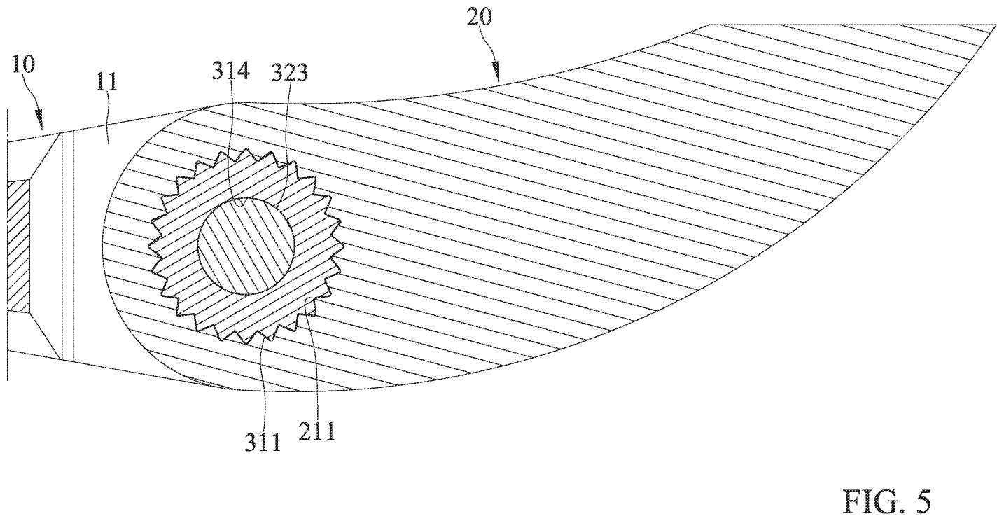

Please refer to FIGS. 4 and 5, the engaging member 31 is in the locked position and the axial member 32 is in the first position, the biasing member 33 is not compressed, and the engaging portion 311 of the engaging member 31 is engaged with the engaging hole 211 of the second pivoting portion 21. Thus, the tool head 20 cannot adjust the angle relative to the rod 10.

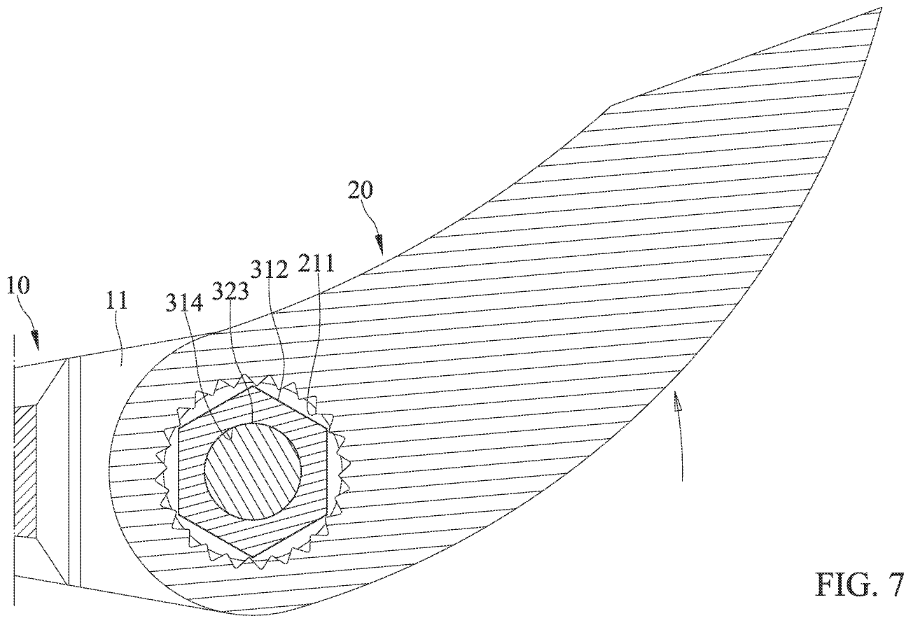

Next, please refer to FIGS. 6 and 7, the pressing portion 321 of the axial member 32 is pressed by an external force, the axial member 32 is moved from the first position to the second position relative to the containing hole 212, and drives the engaging member 31 from the locked position to the unlocked position. The biasing member 33 is compressed, and the engaging portion 311 of the engaging member 31 is disengaged from the engaging hole 211 of the second pivoting portion 21, allowing the tool head 20 to adjust the angle relative to the rod 10. Once the force applied to the pressing portion 321 of the axial member 32 is ceased, the axial member 32 is biased back to the first position from the second position by the biasing member 33.

Although specific embodiments have been illustrated and described, numerous modifications and variations are still possible without departing from the scope of the invention. The scope of the invention is limited by the accompanying claims.

1. An adjustable hand tool comprising:
a rod having a first pivoting portion provided with a limiting hole;
a tool head having a second pivoting portion provided with an engaging hole, a containing hole, and a containing slot communicating with the engaging hole and the containing hole, and wherein the first pivoting portion is pivotally connected to the containing slot; and
a pivoting device including an engaging member and an axial member, wherein the engaging member is movably inserted through the engaging hole and the limiting hole, wherein the engaging member is provided with an engaging portion detachably engaged with the engaging hole, and a limiting portion corresponding to the limiting hole, wherein the axial member is movably inserted through the containing hole, and wherein the axial member is fixedly connected to the engaging member to drive the engaging member, allowing the engaging portion to disengage from the engaging hole.

2. The adjustable hand tool as claimed in claim 1, wherein the engaging member is configured to be driven by the axial member to switch between a locked position and an unlocked position along an axis relative to the engaging hole and the limiting hole, wherein the axial member is configured to move along the axis between a first position and a second position relative to the containing hole;
wherein when the engaging member is in the locked position and the axial member is in the first position, the engaging portion is engaged with the engaging hole;
wherein when the engaging member is in the unlocked position and the axial member is in the second position, the engaging portion is disengaged from the engaging hole.

3. The adjustable hand tool as claimed in claim 2, wherein the engaging member is provided with a through hole penetrating opposite ends of the engaging member along the axis, wherein the axial member is provided with a pressing portion disposed in the containing hole and a body extending from the pressing portion along the axis, and wherein the body is fixedly connected to the through hole.

4. The adjustable hand tool as claimed in claim 3, wherein the through hole is provided with a large diameter portion and a small diameter portion along the axis, and wherein the body is provided with a large diameter section extending from the pressing portion and corresponding to the large diameter portion, and a small diameter section extending from the large diameter section and corresponding to the small diameter portion along the axis.

5. The adjustable hand tool as claimed in claim 4, wherein the through hole is further provided with a riveting portion located on a side of the small diameter portion away from the large diameter portion, wherein the body is further provided with a riveting section extending from the small diameter section and exposed outside the small diameter portion, and wherein the riveting section is riveted to the riveting portion.

6. The adjustable hand tool as claimed in claim 1, wherein the limiting hole is a polygonal hole, and wherein the limiting portion is polygonal columnar in shape.

7. The adjustable hand tool as claimed in claim 6, wherein the limiting hole is a hexagonal hole, and wherein the limiting portion is hexagonal columnar in shape.

8. The adjustable hand tool as claimed in claim 1, wherein at least a part of an inner surface of the engaging hole and at least a part of an outer surface of the engaging portion are provided with corresponding teeth.

9. The adjustable hand tool as claimed in claim 3, wherein the pivoting device further includes a biasing member configured to bias the axial member towards the first position, and wherein the biasing member has two opposite ends respectively elastically abutting against the first pivoting portion and the pressing portion along the axis.

10. The adjustable hand tool as claimed in claim 9, wherein the biasing member is a torsion spring and sleeves around the body.
